(19) United States
(12) Patent Application Publication
(10) Pub. No.: US 2010/0163313 A1
(43) Pub. Date: Jul. 1, 2010

(54) Engineered Bearing Surface For Rock Drilling Bit

(75) Inventors: Chih Lin, Spring, TX (US); Aaron Dick, Houston, TX (US)

Correspondence Address: Bracewell & Giuliani LLP, P.O. Box 61389, Houston, TX, 77208-1389, US

(73) Assignee: Baker Hughes Incorporated, Houston, TX (US)

(21) Appl. No.: 12/648,178

(22) Filed: Dec. 28, 2009

Related U.S. Application Data
(60) Provisional application No. 61/141,433, filed on Dec. 30, 2008.

(51) Int. Cl. E21B 10/00; B24B 1/00; B23P 15/32; B23P 17/00

(52) U.S. Cl. 175/371; 451/48; 76/108.2; 29/527.4

(57) ABSTRACT

A drill bit bearing having a treated surface and method for preparing the same is provided. The method includes the steps of polishing at least one contacting surface of the bearing with an abrasive paste to a finish of less than about 10 μin Ra. The surface of the polishing instrument has a coating that includes a mixture of an epoxy cement and a polymer.

### RELATED APPLICATIONS

This application is a non-provisional of and claims priority to and the benefit of U.S. Provisional Patent Application No. 61/141,433, filed Dec. 30, 2008, incorporated herein by reference in its entirety.

### BACKGROUND OF THE INVENTION

1. Field of the Invention

This invention relates in general to earth-boring rotary cone drill bits and in particular to improved bearing surface treatment.

2. Description of Related Art

Earth-boring bits of the type described herein include a bit body having at least one bearing pin, normally three, and a cone rotatably mounted to each bearing pin. Each cone includes cutting elements for engaging the earth formation as the bit body rotates. The bearing spaces between the cavity of the cone and the bearing pin are typically filled with a lubricant.

Rock boring bits are typically exposed to tough formations, high pressures and high temperatures, each of which contributes to a finite lifetime for the bit. When a rock bit wears out or fails as a bore hole is being drilled, it is necessary to withdraw the drill string for replacing the bit. Prolonging the time of drilling minimizes the lost time in “round tripping” the drill string for replacing bits.

One reason for the replacement of rock bit is failure or wear of the journal bearing on which the cone is mounted. Typically, the journal bearings are subjected to high pressures and temperatures during drilling. Over the recent years, considerable development has gone into the structure and composition of the bearing structures and materials. In certain prior art methods, inlays and various coatings have been applied to the contacting surfaces of the bearing pin to increase the life thereof. In other prior art methods, a series of micropores that include small holes or dimples formed in a pattern have been applied in a pattern over one of the sliding surfaces.

While the prior art methods have improved the lifetimes of drill bits, there still exists a need for a surface treatment for the sliding contact surfaces in roller cone drill bits that provides an increased lifetime.

### SUMMARY OF THE INVENTION

In this invention, a roller cone drill bit is provided wherein at least one of the surfaces of the bearing pin and the rotatably engaged cone has been treated to produce a surface having greater wear resistance.

In one aspect, an earth boring bit is provided, The earth boring bit includes a bit body having a depending bearing pin and a cone having a plurality of cutting elements for engaging a bore hole. The cone includes a cavity that rotatably engages the bearing pin. The cone includes at least one exterior contacting surface and the bearing pin includes at least one interior contacting surface, wherein the at least one exterior contacting surface of the bearing pin engages the at least one interior contacting surface of the cone. At least one of the contacting surfaces includes a hardened surface and a surface coating, wherein the surface coating includes a polymer and a lubricant.

In another aspect, a method for making a roller cone drill bit is provided. The method includes the steps of providing a rock bit body that includes at least one leg depending from the body. A bearing pin depends from said rock bit body, wherein bearing pin includes an exterior contacting surface. A roller cone is provided that includes a cone cavity that includes an interior contacting surface that rotatably engages the exterior contacting surface for the bearing pin. The method further includes polishing at least one contacting surface by positioning an abrasive paste that includes an aluminum oxide and a polymer between a polishing instrument and the at least one contacting surface and polishing the at least one contacting surface. The polishing step reduces the surface roughness of the at least one contacting surface and imparts a polymer coating on the contacting surface.

### BRIEF DESCRIPTION OF THE DRAWINGS

FIG. 1 is a cross sectional view of a roller cone drill bit according to one embodiment of the invention.

FIG. 2 is a partial cross sectional view of a roller cone drill bit according to one embodiments of the invention.

### DETAILED DESCRIPTION

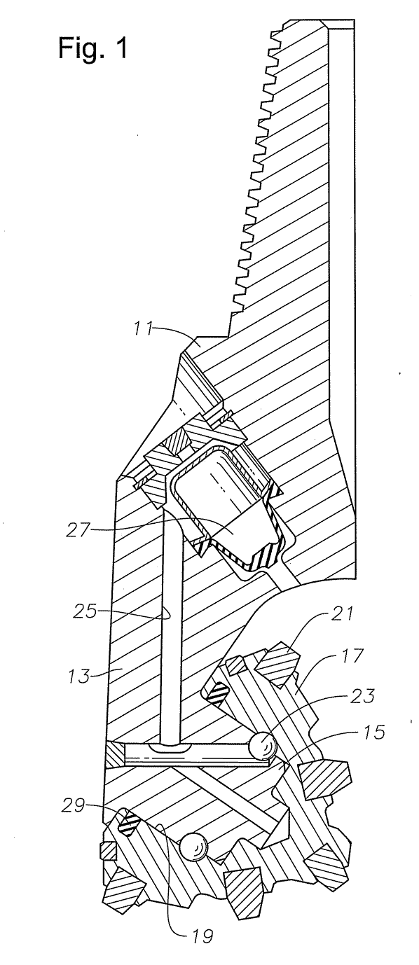

Referring to FIG. 1, the drill bit has a bit body 11 that includes at least one bit leg 13. In certain embodiments, the body 11 includes three bit legs 13. A bearing pin 15 depends downward and forward from each bit leg 13 toward the axis of rotation of the bit. A cone 17 has a cavity 19 that slides over bearing pin 15, allowing cone 17 to rotate relative to bearing pin 15. Cone 17 has a plurality of cutting elements 21 on its exterior. Cutting elements 21 may be tungsten carbide inserts pressed into mating holes, or cutting elements 21 may comprise teeth integrally machined from the body of cone 17. Cone 17 is held on bearing pin 15 by a locking element, which in one embodiment can include a plurality of balls 23 located in mating annular grooves of bearing pin 15 and cone cavity 19.

A lubricant passage 25 extends through each bit leg 13 from a compensator 27 for supplying lubricant to the spaces between the bearing pin 15 and the cone cavity 19. The lubricant fills the regions adjacent to the bearing surfaces and fills various interconnected passageways. A seal 29 is provided to seal lubricant within the bearing spaces. Compensator 27 reduces the pressure differential across seal 29, which is exposed to borehole pressure on its rearward side and lubricant pressure on its forward side. The bit includes a lubricant reservoir, including a pressure compensation subassembly 27 and a lubricant passageway 25, which is connected to the ball passageway by a lubricant passageway. The lubricant is retained in the bearing structure and the various passageways by means of seal assembly 29. Additionally, seal 29 prevents drilled cuttings and drilling fluid from passing the seal and washing out the lubricant and damaging the bearing surfaces.

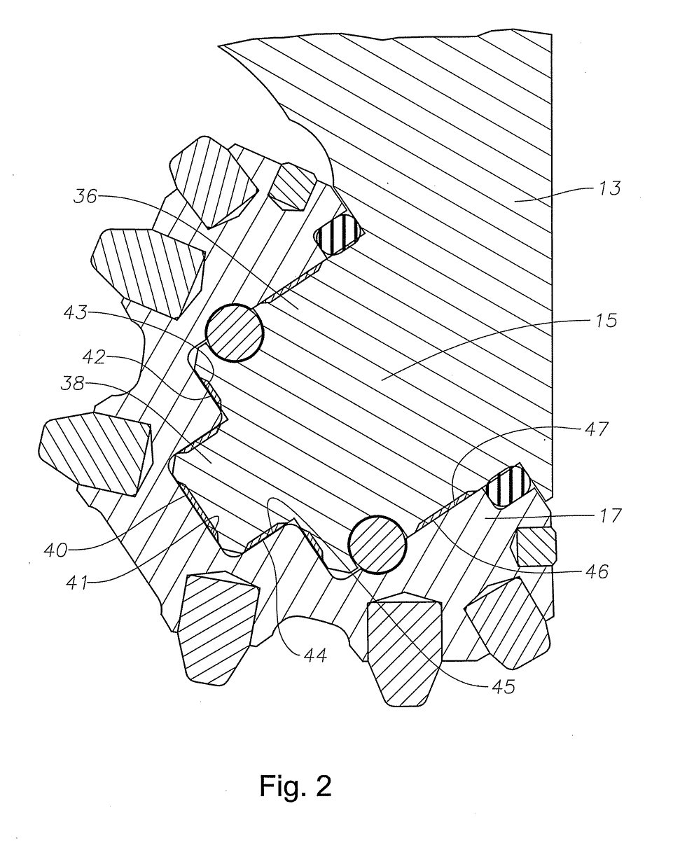

Referring now to FIG. 2, bearing pin 15 includes a base 36 and a head 38, wherein the base and head of the bearing pin are each substantially cylindrical, and wherein the base of the bearing pin is larger in diameter than the head of the bearing pin. The bearing pin 15 rotatably engages cone 17, such that the exterior surface of the bearing pin contacts the interior surface of the cone. Specifically, bearing pin face 40 and thrust face 42, positioned on head 38 and base 36 of bearing pin 15 respectively, and which handle the axial thrust load, contact the interior surface of the cone at locations 41 and 43 respectively. Additionally, bearing pin head 38 includes cylindrical surface 44 and bearing pin base 36 includes cylindrical surface 46, wherein the cylindrical surfaces contact the interior surface of the cone at locations 45 and 47, respectively. As used herein, contacting surfaces shall refer to the contacting surface on both the exterior of bearing pin 15 and the interior of cone 17.

The contacting surfaces of bearing pin 15 can be polished and treated with a polymer coating for improved wear resistance. Optionally, only cylindrical surfaces 44 and 46 of bearing pin 15 are finely polished and treated with a polymer coating. Alternatively, face 40 and thrust face 42 of bearing pin 15 are finely polished and treated with a polymer coating.

In other embodiments of the present invention, the contacting surfaces located on the interior cavity of cone 17 can be polished and treated with a polymer coating for improved wear resistance. For example, interior surfaces 41 and 43 that contact face 40 and thrust face 42 of bearing pin 15, respectively, can be finely polished and treated with a coating. Alternatively, interior surfaces 45 and 47 that contact cylindrical surfaces 44 and 46 of bearing pin 15, respectively, can be finely polished and treated with a polymer coating.

Generally, grinding, polishing and lapping are conventional methods of improving surface quality (e.g., surface finish) and for producing working surfaces for various tribological applications. Grinding, lapping, polishing and cutting can be carried out on materials such as metals, ceramics, glass, plastic, wood and the like, using bonded abrasives such as grinding wheels, coated abrasives, loose abrasives and abrasive cutting tools. Abrasive particles, the cutting tools of the abrasive process, can be naturally occurring or synthetic materials which are generally much harder than the materials which they cut.

Generally, a soft abrasive is selected to abrade or polish a soft material and a hard abrasive to abrade or polish harder types of materials in view of the cost of the various abrasive materials. Typically, the harder the abrasive grain, the more material it will remove per unit volume or weight of abrasive. Highly abrasive materials include diamond and cubic boron nitride, both of which are used in a wide variety of applications.

To achieve a finely polished surface that includes a polymer coating according to the present invention, an abrasive paste that includes abrasive particles is disposed between a polishing instrument and the surface of the bearing pin or the interior of the cone that is being polished. A coating that includes a polymer is disposed on the surface of the polishing instrument. Generally, the surface of the polishing instrument is made of a material that has a lower hardness than that of the surface that is being polished. The exact composition and size distribution of the abrasive particles in the abrasive paste can be selected according to a pre-determined wear pattern and based on the hardness of the material being polished, thereby allowing the roughened surface to be polished or reduced to achieve a pre-determined finish.

In certain embodiments, the abrasive grit is preferably harder than both the surface of the polishing instrument and the surface being polished. Aluminum oxide is one exemplary abrasive material. The abrasive particles may be in contained in a paste or in a viscous solution.

Suitable materials for coating the surface of the polishing instrument include organic polymers. The organic polymers may include a mixture of an epoxy cement and a polyurethane. The polymer coating may have a thickness of between about 0.05 mm and 0.4 mm, prior to the step of polishing the surface of the object being polished. The polymer coat is believed to play a role in achieving a polished surface that has an increased micro-hardness surface. In some embodiments, the polymer coat may have lubricant attracting characteristics or lubricant repelling characteristics. The coating material includes an epoxy cement and a polyurethane at a ratio of about 20:80. It is believed that the epoxy cement provides the adhesion to the metal working surface and the polyurethane provides the toughness and hardness. As applied to the surface being polished, the coating exhibits a high degree of toughness and a high degree of elasticity.

The elastic coating may promote the increased micro-hardness of the resulting surface. The coating may have a thickness of between about 4 mm and 10 mm, or optionally the coating may exceed about 10 mm. The coating on the polishing instrument may be wear resistant with respect to the abrasive paste used in the lapping process. In certain embodiments, the elastic deformation of the coating is such that individual abrasive particles may protrude into, and may be held by, the coating. As individual abrasive particles rotate during the polishing step, the elastic deformation of the coating should enable the particles to be absorbed into the layer in varying depths, according to the varying pressures exerted between the particles and the surface being polished. In part due to the hardness of the abrasive particles, as the particles rotate against the surface that is being polished, they become rounded, rather than being ground into a fine powder. The hardness of the coating may preferably be selected such that the coating does not physically damage the particles. In general, it is preferred that the coating exhibits a strong adhesion to the polishing tool.

The coating on the polishing device can have a ratio of epoxy cement to polyurethane of between about 25:75 to 90:10 by weight. Alternatively, the ratio can be between 35:65 to 80:20; or between 30:70 to 70:30; or between 45:55 to 55:45. Generally, it is believed that the epoxy may contribute hardness to the coating and adhesion (of the coating) to the polishing device and the polyurethane may contribute elasticity and wear-resistance. Additionally, the polyurethane component of the coating may contribute to the deposition of a carbon-containing coating on the surface of the article being polished. The weight ratio of epoxy cement to polyurethane can range from about 1:2 to about 2:1. Alternatively, the weight ratio of epoxy cement to polyurethane can range from about 3:5 to about 7:5.

The coating can include at least about 10% polyurethane by weight. Alternatively, the coating can include between about 20% and 75% polyurethane by weight, between about 40% and 75% polyurethane by weight, or between about 40% and 65% polyurethane by weight.

The coating includes at least about 10% epoxy cement by weight. Alternatively, the coating can include at least about 35% epoxy cement by weight, at least about 40% epoxy cement by weight, or between about 40% and 70% epoxy cement by weight. In other exemplary embodiments, the coating includes at least about 60% epoxy cement by weight, at least about 80% epoxy cement by weight, or up to about 100% epoxy cement by weight.

During the polishing process, abrasive particles initially penetrate into the surface that is being polished and remove a portion of the surface material. As the process continues, the abrasive particles may become rounded, after which point very little material is removed from the surface of the article being polished. Instead, continuing to polish the surface may cause a plastic deformation in the surface being polished, thereby resulting in a surface having an increased micro-hardness. It is also believed that during the plastic deformation of the surface, a polymer layer resulting from the coating applied to the polishing instrument may be included into the structure of the metal surface, and may extend up to several nanometers into the metal surface. The plastic deformation and inclusion of a polymer layer into the surface may result in a thin, hard layer. In one embodiment, the polymer layer in the surface may be associated with a repellant property of the lubricant. Optionally, one or more of the contacting surfaces can be polished to achieve a good flatness rating and good finish of the surface. In preferred embodiments, a free-flowing abrasive material, as opposed to fixed abrasives, are used in the grinding step. The surface finish is less than about 10 μin Ra, preferably less than about 5 μin Ra. Optionally, the polishing step may result in a surface finish that is between about 1 and 3 μin Ra.

The drill bit may include two contact surfaces, wherein the first contact surface is attracted to a lubricant and the second surface is repellant to a lubricant. The first contact surface and the second contact surface can be selected from the bearing pin and the interior cavity of the cone that is rotatably mounted on the bearing pin. The repellant nature of the first contact surface may be the result of either a mechanical or a chemical change of the surface.

Optionally, a chemical coating can be applied to at least one of the contacting surfaces to prepare a repellant surface. The chemical coating can be applied instead of, or in conjunction with, the mechanical modification of the surface, such as for example, by polishing. The chemical coating can be applied wherein the applied chemical surface imparts either an attraction or a repellency to a lubricant. In other embodiments, the chemical coating can be applied as a precursor, and a subsequent step of polishing the surface may result in the curing or plasticization of the chemical coating. It is understood that the chemical coating referred to herein is different than the coating previously described that is applied to the surface of the polishing instrument. Optionally, the surface to which the chemical coating is being applied may be mechanically or chemically pre-treated, prior to the application of the coating. Mechanical pre-treatment of the surface can include the use of microgrooves or partially grinding the surface, or other similar treatment that may provide a surface into which the chemical coating can penetrate for improved adhesion. Alternatively, chemical pre-treatment of the surface can include the application of another chemical compound or coating to provide improved adhesion, such as for example, a chemical etchant or polymer.

The step of polishing the metal surface in accordance with the present invention can include the step of forming a surface that repels the lubricant. The surface can be a compound surface possessing both lubricant attractive zones and lubricant repelling zones. Alternatively, the lubricant repelling zone is a thin exterior layer of the surface being polished, which can be produced either by mechanically processing the working surface, according to the invention as described herein, or by coating the surface with a lubricant-repelling coat.

It is understood that the hardness of the polishing device is dependent upon both the abrasive particles and the hardness of the article being polished. The polishing device can have a Shore D hardness of between about 40 and 90, preferably between about 65 and 90, and more preferably between about 70 and 80.

The polishing device has an impact resistance (as tested with notch) of between about 3 and 12 kJ/m², preferably between about 4 and 9 kJ/m², and more preferably between about 5 and 8 kJ/m².

The coating, as attached or disposed on the polishing tool, has an adhesive strength of at least about 10 kg/cm², preferably at least about 50 kg/cm², more preferably at least about 80 kg/cm², even more preferably at least about 100 kg/cm². In certain embodiments, the coating has an adhesive strength of at least about 120 kg/cm².

The coating applied to the polishing device can include one or more filler materials that may be transferred and incorporated into the surface of the object being polished during the polishing process. Exemplary filler materials can include, but are not limited to, solid lubricants, such as for example, inorganic compounds, organic compounds, and metals in the form of films or particulate materials. The coating filler materials can provide barrier-layer type of lubrication for sliding surfaces, and can be substantially solid at room temperature.

In certain other aspects of the invention, the surfaces can be polished using isotropic superfinishing. Isotropic superfinishing typically refines a surface region having an initial surface roughness of greater than about 10 μin to a polished finish having a surface roughness of less than about 10 μin. Following the polishing, a coating may be applied to the surface, wherein the coating may be selected from a solid lubricant coating or a hard coating. Preferably, the isotropic superfinishing results in a non-directional surface texture. In certain embodiments, the isotropic surface finishing involves scouring the surface region, with or without chemical accelerants, using relative movement between a solid media and the surface region to produce a second surface roughness on the metal. In certain embodiments, the second surface roughness is less than 10 μin Ra and preferably is between 0.25 and 10 μin Ra.

In embodiments employing isotropic superfinishing, in certain embodiments, following the polishing of the surface, a coating can be deposited on the polished surface after polishing. The coating may be a solid lubricious coating or a hard coating, depending on the requirements of the end use or other end user considerations and may be either an amorphous hydrogenated carbon or a transition-metal chalcogenide. The amorphous hydrogenated carbon coating may include a metal to alter the characteristics of the coating, such as for example, titanium or tungsten. Alternatively, the coating may be a transition-metal chalcogenide (sulfides and selenides) coating that includes MoS₂ and WSe₂, however other transition-metal chalcogenide compositions may be used. In other embodiments, the coating can include TiN and TiB₂, although other hard coatings may be utilized. The coating can be deposited on the surface region by a vapor deposition or magnetron sputtering process. Exemplary techniques for the vapor deposition of a coating layer include chemical vapor deposition, physical vapor deposition, and plasma-assisted chemical vapor deposition, however it is to be understood that other deposition processes may also be utilized.

In another embodiment, at least one of the contact surfaces can be treated to produce small grooves on the contact surface. It is believed that the grooves may act as reservoirs for lubricants, while at the same time providing a channel to facilitate the removal of small particulate matter or other debris produced through the engagement of the surfaces during the use of the rotary cone drill bit. Surface treatment to produce grooves can include laser machining, or scoring the surface with a tool such as, for example, a diamond tipped device or wheel, or the like.

Although the following detailed description contains many specific details for purposes of illustration, one of ordinary skill in the art will appreciate that many variations and alterations to the following details are within the scope and spirit of the invention. Accordingly, the exemplary embodiments of the invention described herein are set forth without any loss of generality to, and without imposing limitations thereon, the present invention.

As used herein, optional or optionally means that the subsequently described event or circumstances may or may not occur. The description includes instances where the event or circumstance occurs and instances where it does not occur.

As used herein, recitation of the term about and approximately with respect to a range of values should be interpreted to include both the upper and lower end of the recited range. Ranges may be expressed herein as from about one particular value, and/or to about another particular value. When such a range is expressed, it is to be understood that another embodiment is from the one particular value and/or to the other particular value, along with all combinations within said range.

As used in the specification and claims, the singular form “a”, “an” and “the” may include plural references, unless the context clearly dictates the singular form.

Although the following detailed description contains many specific details for purposes of illustration, one of ordinary skill in the art will appreciate that many variations and alterations to the following details are within the scope of the invention. Accordingly, the exemplary embodiments of the invention described below are set forth without any loss of generality to, and without imposing limitations thereon, the claimed invention.

Throughout this application, where patents or publications are referenced, the disclosures of these references in their entireties are intended to be incorporated by reference into this application, in order to more fully describe the state of the art to which the invention pertains, except when these reference contradict the statements made herein.

We claim:

1. An earth boring bit, comprising:
a bit body;
bearing pin depending from the body;
a cone having a plurality of cutting elements;
a cavity in the cone having a surface that rotably engages the bearing pin;
a surface coating on at least one of the pin and the surface of the cavity, the surface coating comprising epoxy and polyurethane.

2. The bit of claim 1, wherein rounded abrasive particles are embedded in the surface coating.

3. The bit of claim 1, wherein the epoxy cement and polyurethane are in a ratio of between about 25:75 to about 90:10 by weight.

4. The bit of claim 1, wherein the epoxy cement and polyurethane are in a ratio of between about 1:2 to about 2:1 by weight

5. The bit of claim 1, the surface and the surface coating are contained in the cone.

6. The bit of claim 1, wherein the surface and the surface coating are applied to the bearing pin.

7. The bit of claim 1, wherein the surface coating comprises an amorphous hydrogenated carbon.

8. The bit of claim 1, wherein the surface coating comprises a transition-metal chalcogenide.

9. The bit of claim 1, wherein the surface coating repels lubricant.

10. A method for making a roller cone drill bit:
(a) providing a rock bit body having at least one leg depending from said body, a bearing pin depending from said rock bit body, said bearing pin having an exterior contacting surface and a roller cone having a cone cavity, said cone cavity having an interior contacting surface, wherein the interior contacting surface of the cone rotatably engages the exterior contacting surface of the bearing pin; and
(b) polishing at least one contacting surface by positioning an abrasive paste comprising aluminum oxide and a polymer between a polishing instrument and the at least one contacting surface and polishing the at least one contacting surface thereby reducing the surface roughness of the at least one contacting surface and imparting a polymer coating on the contacting surface.

11. The method of claim 10 wherein the surface is polished to a surface roughness of less than about 10 μin Ra before the polymer coating is imparted to the surface.

12. The method of claim 10 wherein step (b) comprises coating a working surface of the polishing instrument with an epoxy cement and a polyurethane.

13. The method of claim 10, wherein step (b) comprises imparting a second polymer coating on a second contacting surface, wherein the polymer coating attracts a lubricant and the second polymer coating repels the lubricant.

14. The method of claim 12, wherein step (b) comprises embedding abrasive particles into the polymer coating.

15. The method of claim 10 wherein the coating on the working surface of the polishing instrument has a thickness of between about 0.05 mm and 0.4 mm.

16. The method of claim 10, wherein step (b) comprises removing a portion of surface material of the contacting surface and increasing the hardness of the contacting surface causing plastic deformation of the contacting surface.

17. The method of claim 10, wherein the polishing device has an impact resistance of between about 3 and 12 kJ/m².

18. A method for making a roller cone drill bit, the method comprising:
(a) providing a rock bit body having at least one leg depending from said body, a bearing pin depending from said rock bit body, said bearing pin having an exterior contacting surface and a roller cone having a cone cavity, said cone cavity having an interior contacting surface, wherein the interior contacting surface of the cone rotatably engages the exterior contacting surface of the bearing pin;
(b) polishing at least one contacting surface by positioning an abrasive paste comprising aluminum oxide and a polymer between a polishing instrument and the at least one contacting surface and polishing the at least one contacting surface thereby reducing the surface roughness of the at least one contacting surface to less than 10 micro-inches Ra;
(c) imparting a polymer coating on the at least one contacting surface, the polymer coating having a thickness of between 4 and 10 mm and adhering to the at least one contacting surface with an adhesive strength of at least 100 kilograms per square centimeter;

19. The method of claim 18, wherein step (b) further comprises creating a non-directional surface texture on the at least one contacting surface.

20. The method of claim 18, wherein step (b) comprises embedding abrasive particles into the polymer coating.
